(19) United States
(12) Patent Application Publication
(10) Pub. No.: US 2007/0226932 A1
(43) Pub. Date: Oct. 4, 2007

(54) Interdental brush

(76) Inventors: Yao-Huang Huang, Shu Lin City (TW); Mu-Hua Huang, Shu Lin City (TW); Chun-Hung Chen, Shu Lin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/648,589

(22) Filed: Jan. 3, 2007

(30) Foreign Application Priority Data
Mar. 28, 2006 (TW) 95110809

(51) Int. Cl. A61C 15/00

(52) U.S. Cl. 15/167.1; 15/143.1; 132/321

(57) ABSTRACT

An interdental brush includes a frame, a brush, a fixing element, and a wrapping element. One inserting aperture is formed at one end of the frame and it is extended inside the frame. The handling portion of the Brush is inserted into the inserting aperture of the frame while the fixing element is inside the frame and attached to the handling portion. The wrapping element wraps the frame and fixing element to have the interdental brush furnished. The interdental brush is soft, bendable, comfortable, and with excellent fixation; therefore, the handling portion of the brush will not be pulled off from the inserting aperture of the frame.

### BACKGROUND OF THE INVENTION

1. Field of the Invention

The present invention relates to an interdental brush is developed specially for personal oral hygiene. It is a soft, bendable, and comfortable product with excellent fixation; moreover, the handling portion of the brush will not be pulled off from the inserting aperture of the frame.

2. Description of the Related Art

An interdental brush is developed for personal oral hygiene. Comparing to conventional hard toothpick, the interdental brush is much softer and easier for clearing the residual food between teeth. As shown in FIG. 1, the interdental brush is with a design of frame (7) that is made of plastic. One inserting aperture (71) is designed at the front end of the frame (7) and the inserting aperture (71) is extended inside the frame (7) along an axial direction of the frame. The inserting aperture (71) of the frame (7) is for a brush to set up (8) and the brush (8) includes one handling portion (81) and one brushing portion (82) arranged in front end of the handling portion (81). The handling portion (81) is inserted into the inserting aperture (71) of the frame (7) and the handling portion (81) of the brush is pressed to form a bend (83) with a tool so that the handling portion (81) of the brush (8) will be positioned inside the inserting aperture (71) of the frame (7). Finally, the wrapping element (9) is formed and it is inside the frame (7) locally. The color of the wrapping element (9) is usually in a different color for beautification and for having the handling portion (81) of the brush (8) covered and fixed.

The conventional interdental brush uses the wrapping element (9) to position the handling portion (81) of the brush (8). The wrapping element (9) is made of soft plastic or hard plastic. The wrapping element (9) made of soft plastic is softer, bendable, and comfortable; however, it is with less satisfactory fixation and the handling portion (81) of the brush (8) could be pulled off (twisted off) from the inserting aperture (71) of the frame (7). The wrapping element (9) made of hard plastic is with better fixation and can prevent the handling portion (81) of the brush (8) pulling off from the inserting aperture (71) of the frame (7); however, it is with less satisfactory softness, bending, and comfort.

### SUMMARY OF THE INVENTION

The purpose of this invention is to have an interdental brush developed with the qualities of softness, bending, comfort, fixation, and preventing the handling portion of the brush from pulling off from the inserting aperture of the frame.

For the said purposes, the invention of the interdental brush includes a frame having an inserting aperture at one end thereof, the inserting aperture extended to an inner of the frame; a brush including a handling portion; and a brushing portion attached to the handling portion; wherein the handling portion of the brush inserted to the inserting aperture of the frame; a fixing element arranged inside the frame and attached to the handling portion of the brush; and a wrapping element wrapping the frame and fixing element.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a cross-sectional view of a conventional interdental brush;

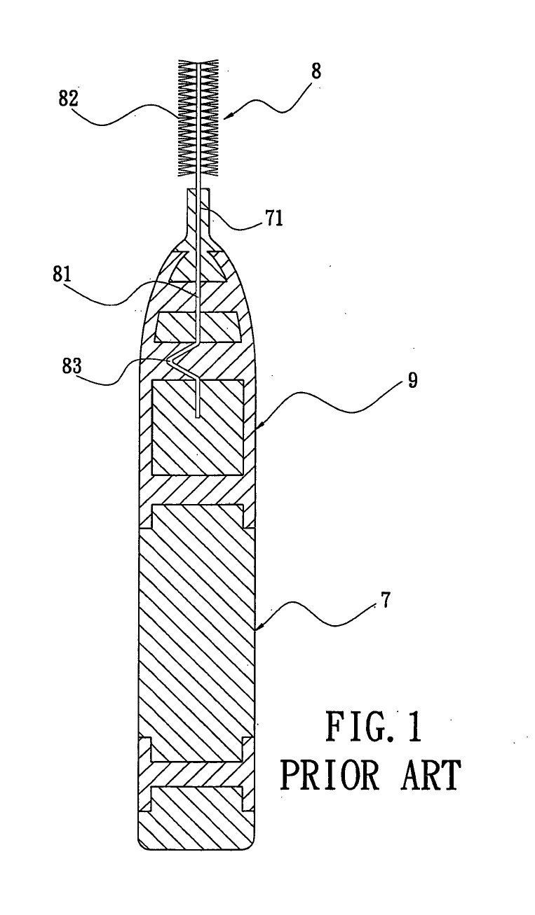

FIG. 2 is a cross-sectional view (1) of a first embodiment of the interdental brush according to the present invention;

FIG. 3 is a cross-sectional view (2) of the first embodiment of the interdental brush according to the present invention;

FIG. 3A is an over view of the first embodiment of the fixing element of the interdental brush according to the present invention;

FIG. 4 is a cross-sectional view of the first embodiment of the interdental brush according to the present invention;

FIG. 5 is a cross-sectional view of a second embodiment of the interdental brush according to the present invention;

FIG. 6 is a cross-sectional view of a third embodiment of the interdental brush according to the present invention;

FIG. 7 is a cross-sectional view of a fourth embodiment of the interdental brush according to the present invention; and

FIG. 8 is a cross-sectional view of a fifth embodiment of the interdental brush according to the present invention.

### DETAILED DESCRIPTION OF THE PREFERRED EMBODIMENTS

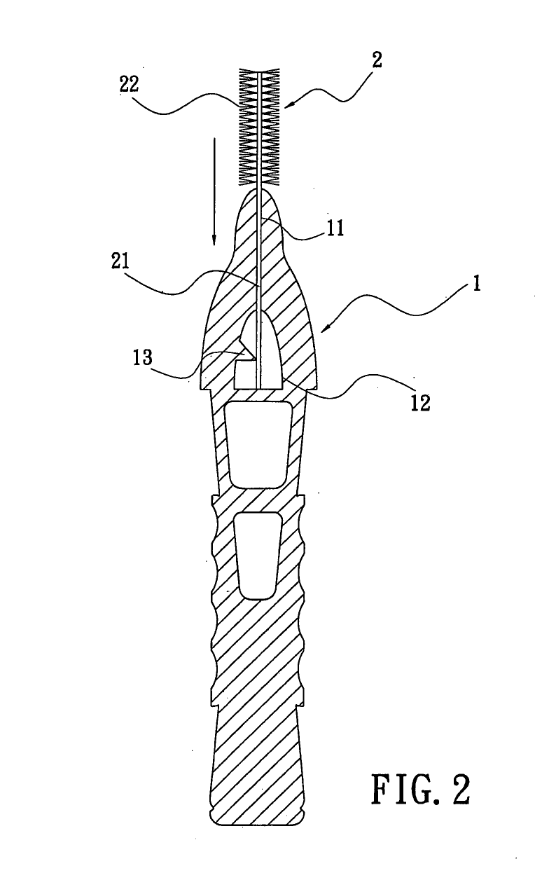

Please refer to FIGS. 2˜4 enclosed, the invention of interdental brush includes a frame (1), a brush (2), a fixing element (3), and a wrapping element (4), in which, the frame (1) is a made of plastic by injection-molding, has a shaped of rectangle or others for easy holding. One inserting aperture (11) is formed at one end of the frame (1) and it is extended inside the frame (1) along an axial direction of the frame (1). A chamber (12) is formed inside the frame (1) to accommodate the fixing element (3) and the wrapping element (4). The extrusion (13) is formed inside the chamber (12) to block and hold the brush (2) so that the brush (2) is fixed to the frame (1) temporarily.

The brush (2) includes a handling portion (21) and a brushing portion (22). The handling portion (21) is made of stainless steel and formed into a long-bar shaped. The brushing portion (22) is fixed in front of the handling portion (21). The handling portion (21) of the brush (2) is inserted in the inserting aperture (11) (as shown in FIG. 2) of the frame (1) front-backwards; moreover, the rear end of the handling portion (21) is extended inside the chamber (12) and the handling portion (21) of the brush (2) is blocked by the extrusion (13); therefore, the brush (2) is fixed to the frame (1) temporarily.

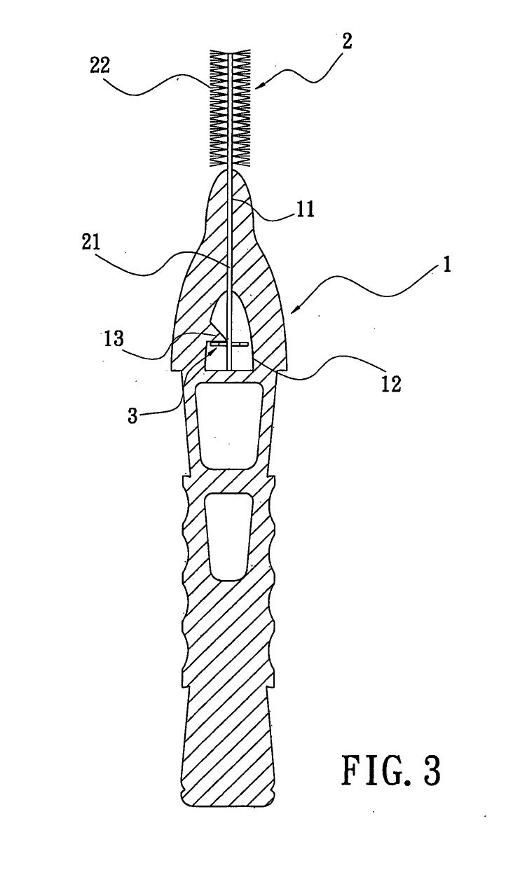

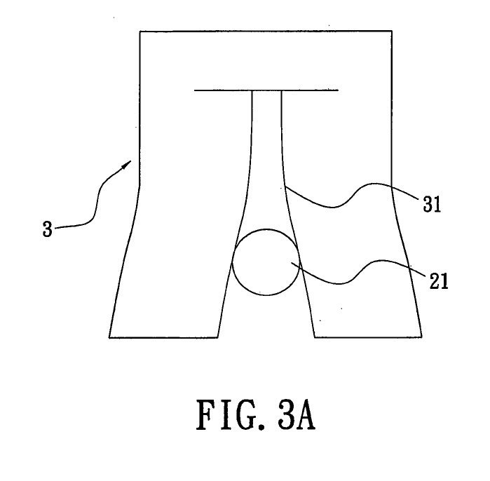

Fixing element (3) is different and independent from the wrapping element (4) and it is made of various materials and structures. In this case, the fixing element (3) is made of metal and is arranged in the chamber (12) of the frame (1); also, it is clinched on the handling portion (21) of the brush (2). The fixing element (3) is with an opening (31) (as shown in FIG. 3 and FIG. 3A) and it is clinched on to the handling portion (21) through the opening (31).

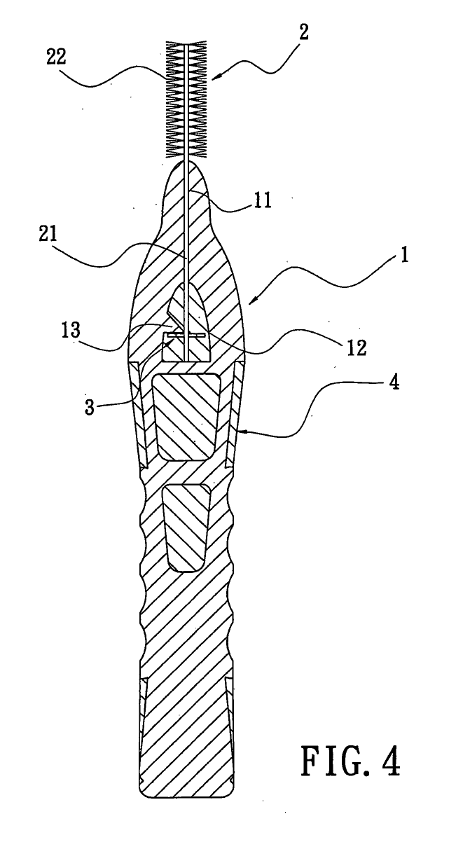

The wrapping element (4) wraps the frame (1) and the fixing element (3) and it is made of plastic by injection-molding. The color of the wrapping element (4) is different (or the same as) from the frame (1). The wrapping element (4) wraps the frame (1) locally (FIG. 4) so that the frame (1) exposes locally to have the interdental brush completed with two colors for beautification. The wrapping element (4) can be used to cover up the handling portion (21) of the brush (2) and the fixing element (3) and the interdental brush is therefore completed and presented.

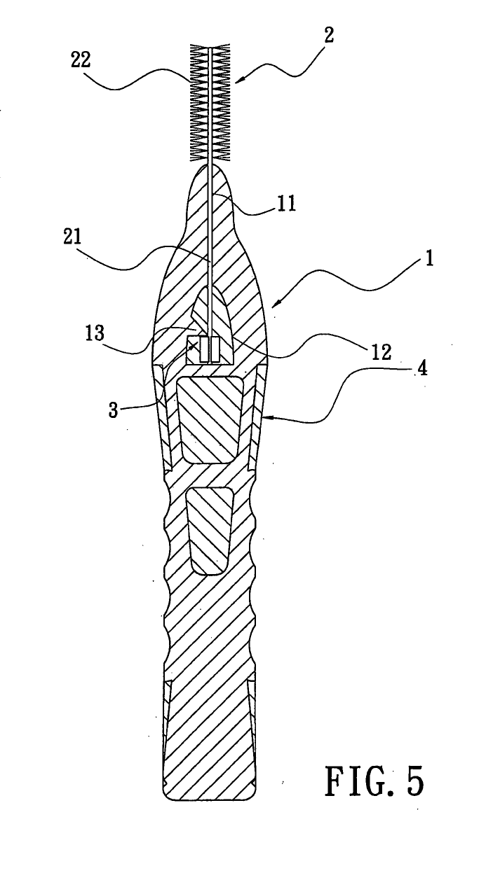

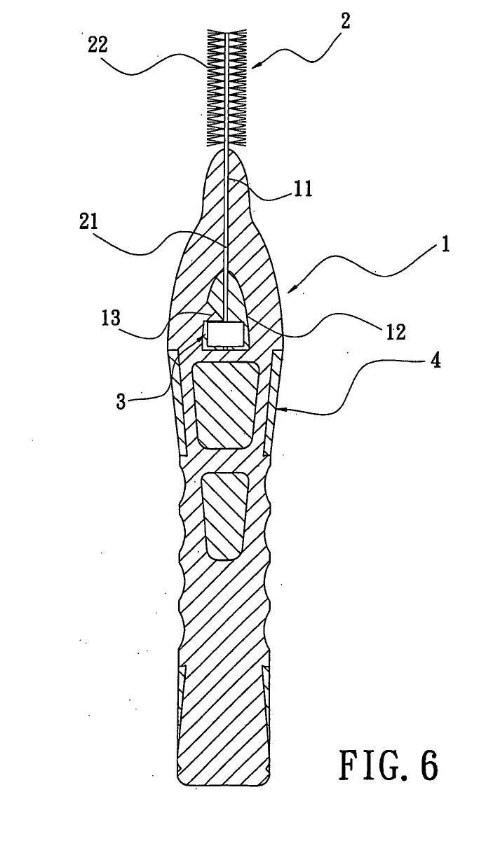

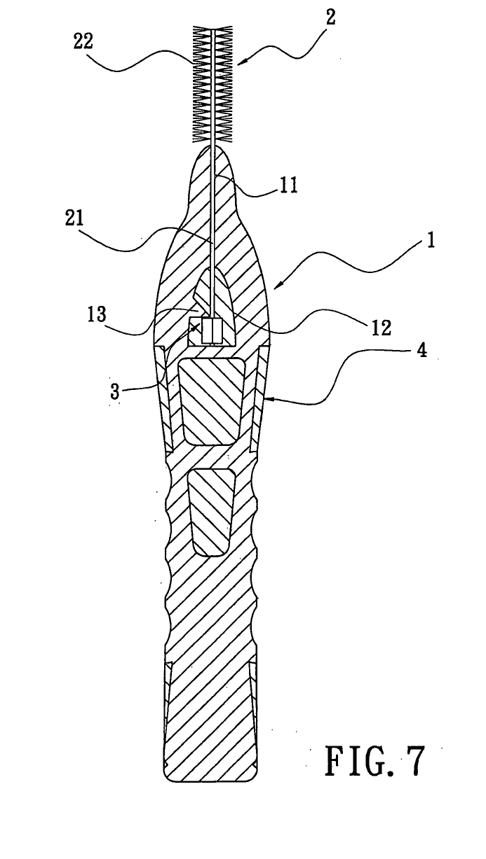

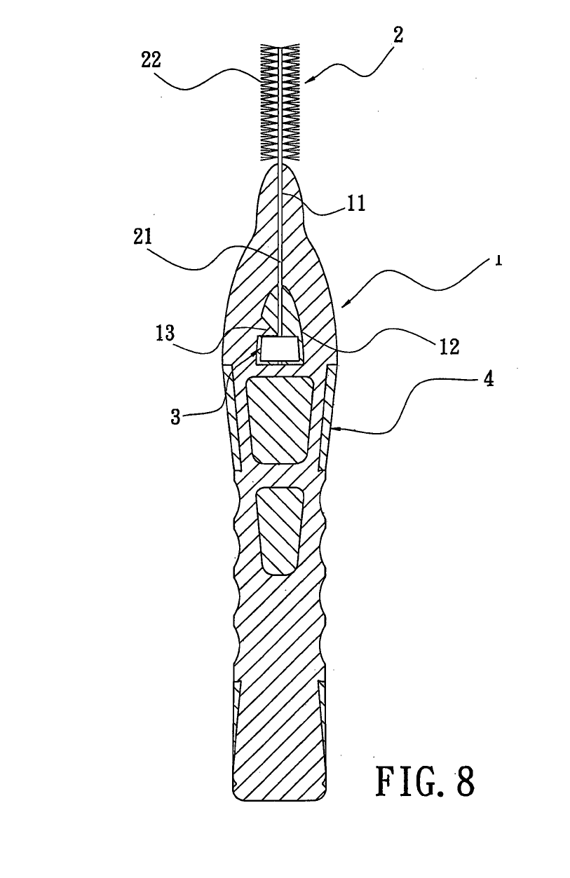

Please refer to FIGS. 5˜8 for the introduction of other inventions that is different from the aforementioned case only in the change of the fixing element (3). Please refer to FIG. 5, the fixing element (3) is made of metal and it is compressed flatly to fix to the handling portion (21) of the brush (2). Please refer to FIG. 6, the fixing element (3) is made of plastic by injection-molding and it is fixed to the handling portion (21) of the brush (2). Please refer to FIG. 7, the fixing element (3) is made of metal and it is pressed to fix to the handling portion (21) of the brush (2). Please refer to FIG. 8, the fixing element (3) is made of plastic by means of ultrasound adhesion and it is fixed to the handling portion (21) of the brush (2).

The invention is to have the handling portion (21) of the brush (2) fixed with the fixing element (3) instead of using the wrapping element (4) to have the handling portion (21) of the brush (2) fixed. Therefore, the wrapping element (4) is made of soft plastic for the qualities of softness, bending, comfort; moreover, the fixing element (3) can have the handling portion (21) of the brush (2) fixed inside the frame (1) excellently against any pulling force that may have the handling portion (21) of the brush (2) pulled off from the inserting aperture (11) of the frame (1).

The aforementioned illustration is for instance instead of having the scope of patent limited; therefore, the modification made to the product by using the instruction for use and drawings of the product is protected within the scope of the patent.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An interdental brush comprising:
a frame having an inserting aperture at one end thereof, the inserting aperture extended to an inner of the frame;
a brush including a handling portion; and a brushing portion attached to the handling portion; wherein the handling portion of the brush inserted to the inserting aperture of the frame;
a fixing element arranged inside the frame and attached to the handling portion of the brush; and
a wrapping element wrapping the frame and fixing element.

2. The interdental brush as claimed in claim 1, wherein the frame is made of plastic.

3. The interdental brush as claimed in claim 1, wherein the frame is long bar-shaped.

4. The interdental brush as claimed in claim 1, wherein the frame forms a chamber at the inner thereof, the fixing element is received inside the chamber, an extrusion is formed at a inner wall of the chamber, and the extrusion is against to the handling portion of the brush so that the brush temporarily fixed to the frame.

5. The interdental brush as claimed in claim 1, wherein the fixing element is made of metal or plastic.

6. The interdental brush as claimed in claim 1, wherein the fixing element is clicked to the handling portion of the brush.

7. The interdental brush as claimed in claim 1, wherein the fixing element is compressed flatly to attach to the handling portion of the brush.

8. The interdental brush as claimed in claim 1, wherein the fixing element is attached to the handling portion of the brush by means of injection molding.

9. The interdental brush as claimed in claim 1, wherein the fixing element is pressed to attach to the handling portion of the brush.

10. The interdental brush as claimed in claim 1, wherein the fixing element is attached to the handling portion of the brush by means of ultrasound.

11. The interdental brush as claimed in claim 1, wherein the wrapping element is made of soft plastic.

12. The interdental brush as claimed in claim 1, wherein the color of the wrapping element is different from that of the frame and the wrapping element wraps the frame locally to have the frame exposed locally.
